(19) United States
(12) Patent Application Publication
(10) Pub. No.: US 2005/0160921 A1
(43) Pub. Date: Jul. 28, 2005

(54) Reduced pressure centifugal extractor for cooking

(76) Inventor: Takuji Ono, Okayama-shi (JP)

Correspondence Address: BACON & THOMAS, PLLC, 625 SLATERS LANE, FOURTH FLOOR, ALEXANDRIA, VA, 22314, US

(21) Appl. No.: 10/515,634

(22) PCT Filed: Sep. 18, 2002
(86) PCT No.: PCT/JP02/09562

(51) Int. Cl. A23N 1/00

(52) U.S. Cl. 99/511

(57) ABSTRACT

Disclosed is a reduced-pressure centrifugal dewatering apparatus for preparing foodstuffs for cooking comprising: a container vessel 12 for holding foodstuffs to be treated; centrifugal means 13 for rotating the so contained food at high speed in the vessel 12; and pressure-reducing means 14 for reducing the pressure in the vessel. A cage or cages 5 are used for holding a given quantity of foodstuffs to be treated, the container vessel 12 being so constructed that it may fixedly hold the cage, allowing it to rotate at high speed. The foodstuffs prepared to be ready for substantive cooking such as precut vegetables thus treated with the present invention can be preserved in a good condition for an elongated period.

### TECHNICAL FIELD

The present invention relates to an apparatus for removing water from washed vegetables and other foodstuffs.

### BACKGROUND ART

Sliced or cut vegetables ready for substantive cooking are called precut vegetables or “ready-for-preparation” vegetables, which are packaged and marketed.

Such precut vegetables are prepared as follows:

First, outer leaves and cores are removed from vegetables, and then the so prepared vegetables are washed with purified water (primary washing). Then, they are cut or sliced into appropriate size with suitable tools such as a cutter and a knife. The so cut or sliced vegetable pieces are sterilized with an aqueous solution of hypochlorous acid sodium. Usually, they are soaked in a sterilization bubble bath of a vegetable washing machine. After sterilization, they are washed again to remove any remaining sterilization agent (secondary washing). Water is removed from the so sterilized vegetable pieces by a centrifugal machine etc. An appropriate protector such as a net may be put on some vegetables which bruise easily. Finally, the so dewatered vegetable pieces are hermetically packaged with nitrogen gas etc. and marketed.

Such precut vegetables can remain in a fresh condition only for four or five days even though they are preserved in refrigerators.

In order to extend the period for which the precut vegetables remain in a fresh condition, some bactericides such as vinegar or fumaric acid are applied after the secondary washing, but disadvantageously, the use of these bactericides tend to injure the tissues of the vegetables on their cut surfaces, which causes browning of the vegetable pieces or ooze of a tissue liquid from injured cut surfaces. Also disadvantageously, the oozing liquid from vegetable pieces turns into a culture solution that cultivates remaining bacteria, and brings about a sanitary problem.

As may be understood from the above, the period for which the precut vegetables remain in a fresh condition can be hardly extended.

One object of the present invention is therefore to provide a reduced-pressure centrifugal dewatering apparatus for producing foodstuffs such as precut vegetables prepared and packaged to be ready for substantive cooking, which can remain in a fresh condition for an extended period of time.

### SUMMARY OF THE INVENTION

To attain this object, a reduced-pressure centrifugal dewatering apparatus for preparing foodstuffs for cooking according to the present invention is constructed as follows:
a reduced-pressure centrifugal dewatering apparatus for preparing foodstuffs for cooking as claimed in claim 1 comprises: a container vessel for holding foodstuffs to be treated; centrifugal means for rotating the so contained foodstuffs at high speed in the vessel; and pressure-reducing means for reducing the pressure in the vessel.

With this arrangement, cut and washed pieces of foodstuffs can be dewatered by rotating at high speed, and then free water existing in tissues of the foodstuffs can be evacuated by reducing the pressure in the vessel. This dual removal of water effectively extends a period for which the treated foodstuffs remain in a fresh condition in comparison to a simple dewatering with a conventional centrifugal apparatus. Still advantageously, the dual removal of water is carried out in one and same vessel making it unnecessary to transfer the treated foodstuffs from place to place, thus it is not only time and labor saving, but also hygienic since a possibility of allowing some airborne bacteria to attach to the foodstuffs while being transferred is eliminated.

The reduced-pressure centrifugal dewatering apparatus for preparing foodstuffs for cooking as claimed in claim 2 comprises: a container vessel; centrifugal means; and pressure-reducing means as described in claim 1, and further comprises a demountable cage or cages for holding a given quantity of foodstuffs to be treated, the container vessel being so constructed that it may fixedly hold the cage, allowing it to rotate at high speed.

With this arrangement, the precut foodstuffs are held in the cage while being dewatered by high-speed rotation and depressurization as mentioned above, and then the so dewatered precut foodstuffs are transferred from the reduced-pressure centrifugal dewatering apparatus to a subsequent stage without being taken out of the cage. This effectively expedites required treatments since the treated foodstuffs do not need to be directly moved from place to place, and also prevents contamination of the precut foodstuffs with bacteria floating in the surrounding atmosphere, which otherwise would be caused while being moved.

### BRIEF DESCRIPTION OF DRAWINGS

A reduced-pressure centrifugal dewatering apparatus according to one preferred embodiment of the present invention will be described with reference to accompanying drawings:

FIG. 1 is a longitudinal section of the reduced-pressure centrifugal dewatering apparatus as viewed from the front of the apparatus;

FIG. 2 is another longitudinal section of the reduced-pressure centrifugal dewatering apparatus as viewed from one side of the apparatus;

FIG. 3 shows how the reduced-pressure centrifugal dewatering apparatus looks in appearance; and

FIG. 4 shows the production line for preparing foodstuffs.

### DETAILED DESCRIPTION OF THE PREFERRED EMBODIMENT

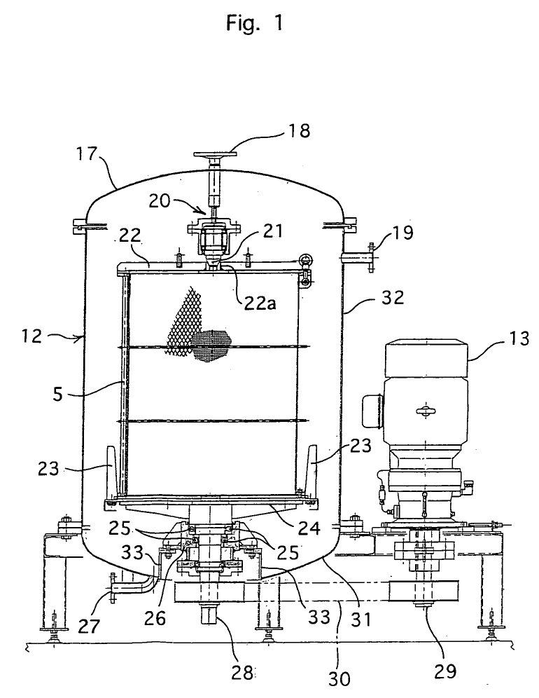

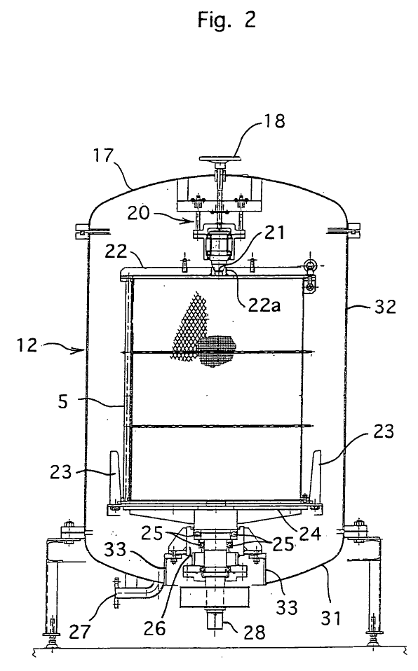

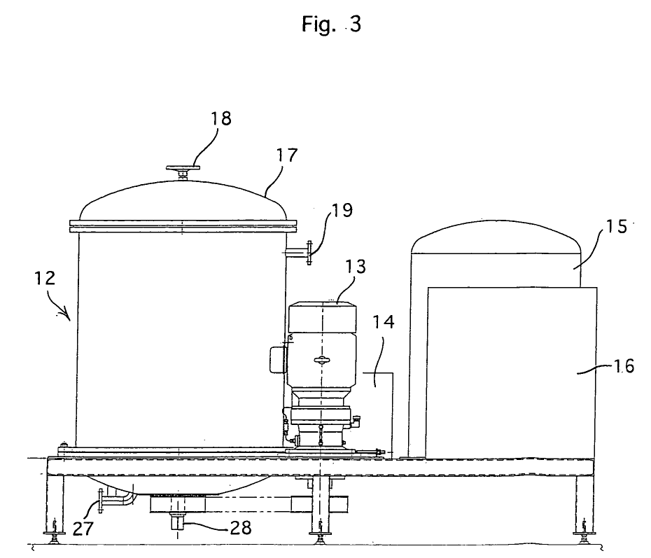

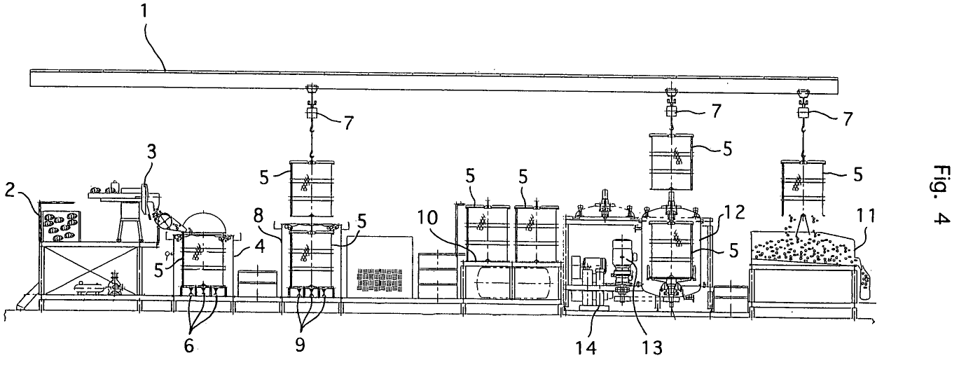

FIG. 1 is a longitudinal section of the reduced-pressure centrifugal dewatering apparatus as viewed in whole from the front; FIG. 2 is another longitudinal section of the apparatus as viewed from one side; FIG. 3 shows how it looks in appearance; and FIG. 4 shows the production line for preparing foodstuffs for cooking.

Precut vegetables are prepared as follows with the present invention:

Firstly, outer leaves and cores are removed from vegetables before cutting (preliminary treatment), and then the so prepared vegetables are washed with purified water (primary washing).

Then, the washed vegetables are cut or sliced into appropriate size by using a cutter 3. The so cut vegetable pieces are put in a sterilizing vessel 4.

The sterilizing vessel 4 holds an aqueous solution of bactericides such as hypochlorous acid sodium to provide a sterilization bath. The cut vegetables are soaked in the sterilization bath while bubbling pipes 6 blow bubbles into the sterilization bath. A cage 5 is loaded in the sterilizing vessel 4 for holding a given amount of the cut vegetables, which is carried and transferred from place to place without removing the vegetables out of the cage 5. Specifically, an overhead crane 7 hanging from a ceiling 1 transfers the cage 5 sequentially from stage to stage in a predetermined order in a production line. FIG. 4 simultaneously shows the cage 5 at various stages in the production line.

After sterilization, the cut vegetables are put in a washing vessel 8, in which they are rinsed to remove any remaining sterilization agent (secondary washing). Bubbling pipes 9 placed underneath blow bubbles while the secondary washing is being performed.

After completely removing the remaining sterilization agent, the cage 5 holding the rinsed vegetables are put on a draining table 10 for a while, and then the cage 5 is transferred to the reduced-pressure centrifugal dewatering apparatus according to the present invention.

The reduced-pressure centrifugal dewatering apparatus comprises: a container vessel 12; an electric motor 13 to rotate the cage 5 at high speed in the vessel 12; and a vacuum pump 14 that draws air from the vessel 12 to reduce the pressure in the vessel 12.

When the crane 7 lowers the cage 5 to put it in the container vessel 12 to be fixedly held, a top cover plate 17 is closed and the cage 5 is rotated at high speed by the electric motor 13. Thus, almost all water remaining on the surface of the cut vegetable pieces is removed by centrifugal force (spin-drying).

Then, the container vessel 12 is depressurized by the vacuum pump 14 so that free water existing in tissues of the cut vegetables pieces may be evacuated (water evacuation).

Both the dewatering processes of spin-drying and water evacuation as described above are carried out in one and same container vessel, making it unnecessary to transfer the vegetable pieces from place to place, thus it is not only time and labor saving, but also hygienic since a possibility of allowing some airborne bacteria to attach to the treated foodstuffs while being transferred is eliminated.

After completing the spin-dying and water evacuation of the vegetable pieces, the cage 5 is taken out of the container vessel 12 and transferred to a packaging machine 11, in which the vegetable pieces are taken out of the cage 5 and packaged per each predetermined quantity. For example, a predetermined quantity of vegetable pieces are put in each bag of gas-barrier packaging material, which is to be hermetically sealed after replacing air in the bag by a nitrogen-and-carbon dioxide mixture gas. Alternatively bags may be made of a certain packaging material whose oxygen transparency is limited within a predetermined range, in which case, an air-and-ethylene gas absorber agent is contained in the hermetically sealed bag.

It is expected that selecting the best fit packaging factors such as packaging materials and filling gases according to a type of treated foodstuffs will, when coupled with the dual dewatering of spin-drying and water evacuation with the present invention as described above, result in a significant extension of the period for which the treated foodstuffs such as precut vegetables remain in a fresh condition.

Referring to FIGS. 1 to 3, the reduced-pressure centrifugal dewatering apparatus according to the present invention is described in detail hereafter.

The container vessel 12, the electric motor 13 to rotate the cage 5 at high-speed in the container vessel 12, and the vacuum pump 14 that draws air from the container vessel 12 to reduce the pressure in the container vessel 12, all together make up the reduced-pressure centrifugal dewatering apparatus.

The container vessel 12 comprises: a cylindrical body 32; a top cover plate 17 to cover the open top of the cylindrical body 32; and a bottom plate 31 detachably fixed to the open bottom of the cylindrical body 32. The container vessel 12 is made of metal or any other appropriate material so that it is stout enough to stand for surrounding atmospheric pressure when being depressurized. The container vessel 12 can be hermetically sealed when the top cover plate 17 is closed.

The cage 5, which holds a given quantity of foodstuffs such as cut vegetables, can be fixedly set in the container vessel 12. A circular turntable 24 is arranged on the bottom of the container vessel 12, and four guide projections 23 stand upright around the turntable 24.

The guide projections 23 are so arranged that they may fit in guide slots provided on the bottom of the cage 5 when it descends on the turntable 24. The turntable 24 has its rotary axle 28 in the middle, rotatably supported by upper and lower bearings 25. These bearings 25 are fastened to an associated bearing mount 26, which, in turn, is supported by a mount frame 33 on the inner side of the bottom plate 31. The rotary shaft 28 of the turntable 24 passes through the bottom plate 31, and the driving power is transmitted from the electric motor 13 to the rotary shaft 28 via an associated speed reduction mechanism.

The top cover plate 17 of the vessel 12 has a vertical slider 20 inside the cover and an associated steering wheel 18 outside the cover. Clockwise or counter clockwise rotation of the steering wheel 18 moves a center axle 21 of the vertical slider 20 up or down. The cage 5 has a lid 22 on its top, and the lid 22 has an aperture 22a made at its center. When the center axle 21 descends, its lower tip end comes to fit in the aperture 22a of the lid 22.

As described above, the cage 5 is rotated in the container vessel 12 by the electric motor 13. Specifically, a driving power is transmitted from the electric motor 13 to the rotary shaft 28 of the turntable 24 via the speed reduction mechanism provided on an outputting axle 29 and a transmission belt 30.

FIG. 3 shows how the reduced-pressure centrifugal dewatering apparatus looks in appearance. The vacuum pump 14 is used to evacuate the container vessel 12, and a vacuum buffer tank is indicated by 15. A control box 16 is used to control the reduced-pressure centrifugal dewatering apparatus. When it is desired that inner pressure of the vessel 12 returns to a surrounding atmospheric pressure, the air is drawn into the vessel 12 via a valve 19, which is located at the upper side of the cylindrical body 32. The water removed from the vegetable pieces remains on the bottom of the container vessel 12, and the remaining water is drained from the container vessel 12 through a drain valve 27, which is attached to the bottom of the container vessel 12.

The reduced-pressure centrifugal dewatering apparatus according to the present invention is constructed as described above and works as follows:

The cage 5 holding the rinsed vegetable pieces hangs from the crane 7 and descends into the container vessel 12. Then, the cage 5 is guided with the guide projections 23 fitted in the bottom slots of the cage 5 so that it may be set in position. The top cover plate 17, which is open in the beginning, is closed upon having the cage 5 set in the vessel 12. Then, the steering wheel 18 is rotated to lower the center axle 21 until it fits in the vertical aperture 22a of the lid 22 of the cage 5. Thus, the cage 5 is put in condition for high-speed rotation in the container vessel 12.

Then, the electric motor 13 is energized to rotate the cage 5 at high speed in the container vessel 12. The inner pressure of the container vessel 12 remains at the surrounding atmospheric pressure. Almost all water remaining on surface of the vegetable pieces is removed by spin-drying under the centrifugal influence as earlier mentioned. The spin-drying generally takes only ten or less minutes, although the length of time required varies depending on a type of treated foodstuffs.

Then, the container vessel 12 is depressurized by the vacuum pump 14 so that not only still remaining water on the surface but also free water within the tissues may be removed from the vegetable pieces. The degree of lowering the inner pressure for the dewatering purpose varies depending on a type of treated foodstuffs. As for the vegetable pieces, five to seven percent of the free water can be removed by lowering the inner pressure down to three to ten torr.

After finishing the dewatering in the reduced-pressure condition, the valve 19 is gradually opened to raise the inner pressure of the vessel 12 up to the surrounding atmospheric pressure. The steering wheel 18 is rotated to raise the center axle 21, opening the top cover plate 17. Then, the cage 5 is pulled out of the container vessel 12 by the crane 7 and transferred to the packaging machine 11. The remaining water in the container vessel 12 is drained off through the drain valve 27.

As may be understood from the above, both the dewatering processes by high-speed rotation and depressurization can be carried out in one and same apparatus with the present invention, making it unnecessary to transfer the treated foodstuffs from place to place, thus it is not only time and labor saving, but also hygienic since a possibility of allowing some airborne bacteria to attach to the foodstuffs while being transferred is eliminated. Furthermore, the treated foodstuffs are held in the cage 5 detachably loaded in the vessel 12 while being dewatered by high-speed rotation and depressurization, and then transferred from the vessel 12 to a subsequent stage without being taken out of the cage 5. This effectively expedites required treatments since the treated foodstuffs do not need to be directly moved when removing from the vessel 12, and also prevents contamination of the precut foodstuffs with bacteria floating in the surrounding atmosphere, which otherwise would be caused while being moved.

The reduced-pressure centrifugal dewatering apparatus according to the present invention should not be understood as being limited to dewatering of vegetable pieces. For example, the reduced-pressure centrifugal dewatering apparatus may be equipped with steam nozzles or infrared heaters to raise the inner temperature of the vessel 12 for treating frozen food such as frozen chicken. First, the inner temperature of the container vessel 12 is raised to steam and defrost the frozen chicken placed in the vessel 12, and then, the vessel 12 is rotated at high speed to remove oil from the defrosted chicken under the centrifugal influence, and then the dewatering is carried out in the depressurized condition. In case that frozen chestnuts are treated, the inner temperature of the container vessel 12 is elevated to steam and defrost frozen chestnuts, and then water is removed so that all chestnuts may be equalized in water content. Another water removal is carried out in the depressurized condition while being exposed to infrared rays.

Modification and application of the above-described reduced-pressure centrifugal dewatering apparatus to foodstuffs other than vegetables is obvious to those skilled in the art.

### Industrial Applicability

As is apparent from the above, the reduced-pressure centrifugal dewatering apparatus as claimed in claim 1 comprises: a container vessel for holding foodstuffs to be treated; centrifugal means for rotating the so contained foodstuffs at high speed in the vessel; and pressure-reducing means for reducing the pressure in the vessel. In operation, washed foodstuffs can be spin-dried by rotating at high speed, and free water existing in tissue of the foodstuffs can be evacuated by reducing the pressure in the vessel. This dual removal of water effectively extends a period for which the treated foodstuffs remain in a fresh condition in comparison to a simple dewatering with a conventional centrifugal apparatus. Still advantageously, both the dewatering processes by high-speed rotation and depressurization are carried out in one and same vessel, making it unnecessary to transfer the treated foodstuffs from place to place, thus it is not only time and labor saving, but also hygienic since a possibility of contaminating the foodstuffs with airborne bacteria while being transferred is eliminated.

The reduced-pressure centrifugal dewatering apparatus as claimed in claim 2 further comprises a demountable cage or cages for holding foodstuffs to be treated, the container vessel being so constructed that it may fixedly hold the cage, allowing it to rotate at high speed. With this arrangement, the precut foodstuffs are held in the cage while being dewatered by high-speed rotation and depressurization, and then the so dewatered precut foodstuffs are transferred from the reduced-pressure centrifugal dewatering apparatus to a subsequent stage without being taken out of the cage. This effectively expedites required treatments since the treated foodstuffs do not need to be directly moved from place to place, and also prevents contamination of the precut foodstuffs with bacteria floating in the surrounding atmosphere, which otherwise would be caused while being moved.

1. A reduced-pressure centrifugal dewatering apparatus for preparing foodstuffs for cooking comprising: a container vessel for holding foodstuffs to be treated; centrifugal means for rotating the so contained foodstuffs at high speed in the vessel; and pressure-reducing means for reducing the pressure in the vessel.

2. A reduced-pressure centrifugal dewatering apparatus for preparing foodstuffs for cooking according to claim 1 wherein it further comprises: a demountable cage or cages for holding a given quantity of foodstuffs to be treated; the container vessel being so constructed that it may fixedly hold the cage, allowing it to rotate at high speed.
